(19) United States
(12) Patent Application Publication
(10) Pub. No.: US 2004/0244423 A1
(43) Pub. Date: Dec. 9, 2004

(54) Method of manufacturing an optical glass element

(75) Inventors: Thunnakart Boontarika, Atsugi-shi (JP); Shigeaki Ohmi, Tokorozawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/808,322

(22) Filed: Mar. 25, 2004

(30) Foreign Application Priority Data
Mar. 28, 2003 (JP) 89529/2003

(51) Int. Cl. B05D 5/06

(52) U.S. Cl. 65/102; 427/535; 427/162

(57) ABSTRACT

The present invention relates to a method of manufacturing an optical element by press molding in a pressing mold a heat-softened molding material such as a glass material to form a glass element, and then forming an optically functional film such as an antireflective film thereon. The method of manufacturing an optical element comprises: press molding a heat-softened molding material in a pressing mold to form an optical element of desired shape, and forming an antireflective film on the surface of the optical element obtained, wherein the antireflective film is formed on the optical element having a surface free energy of greater than or equal to 60 mJ/m². The other method of manufacturing an optical element comprises: press molding a heat-softened molding material in a pressing mold to form an optical element of desired shape, and forming an antireflective film on the surface of the optical element obtained, wherein the optical element is subjected to UV ozone cleaning, or plasma cleaning prior to forming the antireflective film.

### TECHNICAL FIELD

The present invention relates to a method of manufacturing an optical element by press molding in a pressing mold a heat-softened molding material such as a glass material to form a glass element, and then forming an optically functional film such as an antireflective film thereon.

### BACKGROUND ART

Press molding methods as methods of molding precision optical glass elements easily and with good production efficiency is known. One known press molding method comprises preparing a molding glass material of prescribed shape by solidifying the melt glass or cold glass processing, introducing the glass material into a pressing mold, pressing the glass material while it is the state of heat-soften and being moldable, and cooling the molded glass kept in the mold to obtain a glass element. Since a precision processed mold is employed, this method does not require polishing the glass element after molding. Accordingly, it is particularly advantageous for manufacturing lenses having aspherical surfaces.

Unexamined Japanese Patent Application (KOKAI) Heisei No. 9-12340 (Reference 1) describes cleaning a press molded glass element with an acid or alkaline solution to remove a denatured layer prior to forming an antireflective film.

Further, the method of forming a film on the surface of the glass material to prevent fusion of the glass to the surface of the pressing mold during press molding is known. Examined Japanese Patent Application (KOKOKU) Heisei No. 2-31012 (Reference 2) describes a method of preventing fusion by forming a carbon film on at least one or the other of the mutually opposing surfaces of the glass and the mold.

### DISCLOSURE OF THE INVENTION

In the method described in Reference 1, it is impossible to fully exclude the possibility that components of the acid or alkaline solution will adsorb onto the glass surface and remain, or even when an antireflective film is formed, that the film will separate or form unevenly due to storage conditions prior to film formation.

Forming a carbon coating on the surface of a glass material prior to press molding in the manner described in Reference 2 enhances mold separation and thus effectively prevents fusion of the glass to the surface of the pressing mold. However, this coating tends to remain on the optical member after press molding. When an antireflective film is formed thereover, problems such as film weakening (poor film adhesion and a tendency to peel), film separation, film unevenness (the film forms unevenly, causing reflective properties to vary across the film), and film scorching (reflective properties slip overall) tend to develop. Although it is possible to remove the carbon coating by heating in air, since a press-molded optical element is molded with high surface precision by press molding, there is a risk that surface precision will deteriorate during heat treatment at elevated temperature. In particular, heat treatment of optical elements not requiring annealing following molding compromises surface precision or causes optical constants to change, and is thus sometimes undesirable. However, when the heat treatment step is omitted, or when the temperature employed in the heat treatment is relatively low, the carbon coating remains. When an antireflective film is formed, problems such as film weakening, film separation, film unevenness, and film scorching develop.

Accordingly, in light of the above problems, the present invention has for its object to provide a method of manufacturing optical glass elements in which the state of the surface layer of a press-molded optical glass element can be uniformly and constantly regulated so that problems such as film weakness, film separation, film unevenness, and film scorching do not occur in the antireflective film that is formed.

The first mode (Mode 1) of the present invention relates to a method of manufacturing an optical element, comprising:

press molding a heat-softened molding material in a pressing mold to form an optical element of desired shape, and

forming an antireflective film on the surface of the optical element obtained,

wherein the antireflective film is formed on the optical element having a surface free energy of greater than or equal to 60 mJ/m².

The method of manufacturing of the present invention may further comprises, prior to the forming of the antireflective film, a step in which the surface free energy of the optical element obtained by press molding is increased to greater than or equal to 60 mJ/m².

In the method of manufacturing of the present invention, the optical element having surface free energy of greater than or equal to 60 mJ/m² can be obtained by subjecting the optical element obtained by press molding to wet cleaning, UV ozone cleaning, or plasma cleaning.

The second mode (Mode 2) of the present invention relates to a method of manufacturing an optical element, comprising:

press molding a heat-softened molding material in a pressing mold to form an optical element of desired shape, and

forming an antireflective film on the surface of the optical element obtained,

wherein the optical element is subjected to UV ozone cleaning, or plasma cleaning prior to forming the antireflective film.

In the method of manufacturing of the present invention, the optical element obtained by press molding can be stored in a clean atmosphere with a cleanliness class of less than or equal to 1,000 until formation of the antireflective film; and the molding material can have a carbon-containing film on an outer surface thereof.

According to the present invention, when forming an antireflective film on an optical glass element obtained by press molding a glass material with a pressing mold while the glass material is in a heat-softened state, and subjecting the surface of the optical glass element upon which the antireflective film is to be formed to a high degree of cleaning, preferably maintaining the surface free energy at greater than or equal to 60 mJ/m² is effective. Accordingly, it is possible to prevent the occurrence of defects such as film weakening, film separation, film unevenness, and film scorching, and obtain a high-quality antireflective film stably and at high yield.

Further, in press molding, the formation of a film enhancing mold separation such as a carbon film on the glass material sometimes compromises adhesion of the antireflective film to the optical element after molding. The use of the cleaning method of the present invention at such times permits the formation of a high-quality antireflective film.

### BRIEF DESCRIPTION OF DRAWINGS

FIG. 1 is a drawing descriptive of the optical element upon which is to be coated an antireflective film.

FIG. 2 is an example of the reflection spectrum of an optical glass element coated with an antireflective layer.

### BEST MODE OF IMPLEMENTING THE INVENTION

Both Modes 1 and 2 of the present invention are methods of manufacturing optical elements comprising press molding with a pressing mold a heat-softened molding material to mold an optical element of desired shape, and forming an antireflective film on the surface of the optical element obtained.

In Mode 1 of the present invention, the antireflective film is formed on an optical element having a surface free energy of greater than or equal to 60 mJ/m².

A step of increasing the surface free energy of the optical element obtained by molding to greater than or equal to 60 mJ/m² is desirably provided prior to forming the antireflective film.

An optical element having a surface free energy of greater than or equal to 60 mJ/m² can be obtained by subjecting the optical element following press molding to, for example, wet cleaning, UV ozone cleaning, or plasma cleaning.

In Mode 2 of the present invention, the optical element is subjected to UV ozone cleaning or plasma cleaning prior to formation of an antireflective film. That is, the step of increasing the surface free energy of the optical element to greater than or equal to 60 mJ/m² can be conducted by, for example, UV ozone cleaning, or plasma cleaning.

The optical element in the present invention may consist of glass, resin, or the like, but will be described below with respect to an optical glass element. The present invention is described in detail below with reference to the figures.

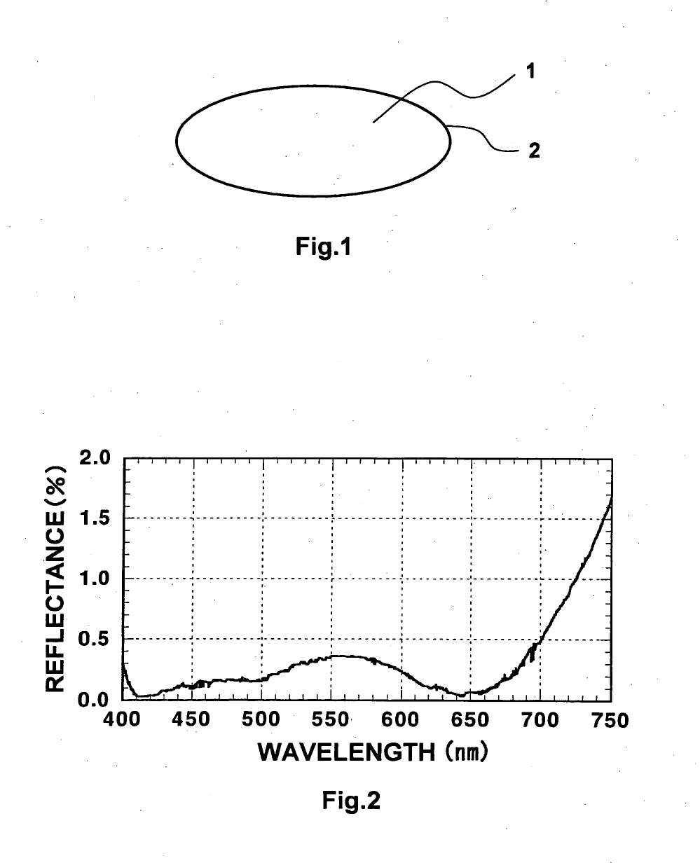

FIG. 1 is a sectional view of the typical press-molded glass element 1 upon which an antireflective film has been formed that is employed in the present invention. Optical element 1 is an optical element of desired shape obtained by press molding in a pressing mold a heat-softened molding material. The surface free energy on the surface thereof is increased to greater than or equal to 60 mJ/m² by cleaning or by cleaning and storage in a clean atmosphere, as set forth further below.

The optical glass element can be press molded by known methods. For example, the glass material can be introduced into a pressing mold that has been processed to a precise shape, softened by heating to a temperature corresponding to a viscosity of from 10⁸ to 10¹² poises, and pressed to transfer the molding surface of the mold to the glass material. Alternatively, a glass material that has been preheated to a temperature corresponding to a viscosity of 10⁶ to 10^{8.5} poises can be introduced into a pressing mold that has been processed to a precise shape (preferably heated to a temperature corresponding to a glass viscosity of 10⁸ to 10¹²) and pressed to transfer the molding surface of the mold to the glass material. The atmosphere during molding is desirably nonoxidizing to protect the surface of the mold. Subsequently, the mold and glass material are cooled, and preferably when a temperature of less than or equal to the Tg has been reached, the optical element is separated from the mold and recovered.

A layer comprised chiefly of carbon is desirably provided on the glass material employed in the method of manufacturing of the present invention to impart mold separating and slipping properties to the surface. The thin film comprised chiefly of carbon may be selected from among diamond, diamond-like carbon films (DLC hereinafter), hydrogenated diamond-like carbon films (DLC:H hereinafter), tetrahedral amorphous carbon films (ta—C hereinafter), hydrogenated tetrahedral amorphous carbon films (ta—C:H hereinafter), amorphous carbon films (a—C hereinafter), hydrogenated amorphous carbon films (a—C:H), and self-assembled films obtained from starting materials in the form of organic compounds. Self-assembled films, known in the literature through Hiroyuki SUGIMURA, Osamu TAKAI, Research Data from the 199^{th} Meeting of the 131^{st} Thin Film Committee of the Japan Science Promotion Association, Feb. 1, 2000, p. 34-39; and Seunghwan Lee, Young-Seok Shon, Ramon Colorado, Jr., Rebecca L. Guenard, T. Randall Lee, and Scott S. Perry; Langmuir Vol. 16 (2000), p. 2220-2224, for example, are films in which molecules self-arrange and self-assemble on the surface of a substrate.

The thickness of the carbon-containing film is 0.1 to 500 nm, preferably 0.1 to 10 nm.

The carbon-containing film may be formed by CVD, DC-plasma CVD, RF-plasma CVD, microwave plasma CVD, ECR-plasma CVD, optical CVD, laser CVD, and other plasma CVD methods; ion plating and other ionization vapor deposition methods; sputtering; vapor deposition; FCA; immersion in the coating liquid of a self-assembled film; and the like.

In addition to SiC, the base material of the pressing mold may be selected from among the group of materials consisting of WC, TiC, TaC, BN, TiN, AlN, Si₃N₄, SiO₂, Al₂O₃, ZrO₂, W, Ta, Mo, cermet, cyalon, mullite, carbon composite (C/C), carbon fiber (CF), and WC—Co alloy. These base materials can be precision molded into desired shapes for use as pressing molds.

A mold separation film is desirably provided on the surface of the pressing mold. The mold separation film may be in the form of a carbon-based coating such as a diamond-like carbon film (DLC hereinafter), hydrogenated diamond-like carbon film (DLC:H hereinafter), tetrahedral amorphous carbon film (ta—C hereinafter), hydrogenated tetrahedral amorphous carbon film (ta—C:H hereinafter), amorphous carbon film (a—C hereinafter), and hydrogenated amorphous carbon film (a—C:H); a nitride coating such as Si₃N₄, TiAN, TiCrN, CrN, CrₓN_{y}, AlN, TiN, and composite multilayered film or laminate film (such as AlN/CrN and TiN/CrN); or a noble metal alloy coating comprising a major component in the form of platinum, such as Pt—Au, Pt—Ir—Au, and Pt—Rh—Au.

The mold separation film may be formed by a method such as DC-plasma CVD, RF-plasma CVD, microwave plasma CVD, ECR-plasma CVD, optical CVD, laser CVD, and other plasma CVD methods; ion plating and other ionization vapor deposition methods; sputtering; vapor deposition; and FCA. The film is from 0.1 to 1,000 nm, preferably from 10 to 500 nm, in thickness.

In the manufacturing method of the present invention, an antireflective film is formed on the surface of the optical element obtained. The film structure of the antireflective film is suitably designed with known materials (such as SiO₂, TiO₂, ZnO₂, and Al₂O₃) employing thin films of varying refractive indexes either singly or in combination in view of the application.

The antireflective film may be formed by a known method such as vapor deposition, ion-assisted vapor deposition, ion plating, or sputtering.

In the case of vapor deposition, a known vapor deposition device can be employed to heat a vapor deposition material in a vacuum atmosphere of about 10⁻⁴ Torr, for example, with an electron beam, direct current, or an arc. The vapor that is generated by vaporization and sublimation from the material is transported onto the substrate and condensed or precipitated to form a thin optical film (antireflective film). The substrate may be heated to a temperature of from room temperature to about 400° C. However, when the glass transition temperature (Tg) of the substrate is less than or equal to 450° C., the maximum temperature to which the substrate may be heated may be set to 50° C. below the Tg.

In the case of ion plating, a known ion plating device can be employed to heat a vapor deposition material in an argon atmosphere of about 10⁻² to 10⁻⁴ Torr with an electron beam. The vapor that is generated by vaporization and sublimation from the material is deposited on a negatively biased substrate to form the thin optical film. A glow discharge between the filament and substrate electrode enhances the adhesive strength and uniformity of deposition. The substrate may be heated to a temperature of from room temperature to about 400° C. However, when the glass transition temperature (Tg) of the substrate is less than or equal to 450° C., the maximum temperature to which the substrate may be heated may be set to 50° C. below the Tg.

In the case of sputtering, a known sputtering device may be employed to sputter a target material with argon ions in an argon atmosphere of about 10⁻² to 10⁻³ Torr, for example. The sputtered particles are transported, causing particles of material to precipitate on the surface of the substrate and form a thin optical film. The substrate may be heated to a temperature of from room temperature to about 400° C. However, when the glass transition temperature (Tg) of the substrate is less than or equal to 450° C., the maximum temperature to which the substrate may be heated may be set to 50° C. below the Tg.

The thickness of the antireflective film may be suitably selected in view of the application; in the case of a laminate, the film thickness may be from 100 to 5,000 nm. When forming the film, the thickness of the film may be actually measured by QCM or by change in the reflectance or transmittance of the optical thin film on monitoring glass, and controlled by opening and closing a shutter.

Detailed examination by the present inventors revealed that most defects such as film weakness, film separation, film unevenness, and film scorching in the antireflective film that is formed occur because of grime or surface contamination on the surface of the optical element upon which the film is formed. Surface analysis by ESCA and the like revealed that the chief components of the grime were alkali metal-based grime (alkali metal-containing chlorides, carbonates, and hydroxides) and organic grime not contained in the optical element upon which the film is formed. It was also found that coated carbon remained on the glass element.

It is difficult to directly evaluate these forms of grime. However, the present inventors discovered that the grime on the surface of the optical element on which the film is formed could be quantitatively evaluated by means of surface free energy.

The level of surface free energy can generally be quantitatively evaluated by contact angle measurement using pure water, CH₂I₂, glycerin, isopentane, perflourooxane, and the like in a known contact angle measurement device. The level of surface free energy can be obtained by calculation from the measurement of the contact angles of two of the above liquids on the surface being measured.

According to the present invention, the surface free energy can be evaluated, for example, by the Owens-Wendt-Kaelble method. For example, the surface free energy can be evaluated by the Owens-Wendt-Kaelble method based on measurement of the wetting angles of pure water and CH₂I₂ in the following manner. The surface free energy (γ) is given by the sum of the dispersion force γ^{d} and the polar interaction force γ^{P} of the liquids.

γ=γ^{d}+γ^{P} (1)

Considering Equation (1) as the surface free energy of a solid gives Equation (2):

γₛ=γₛ^{d}+γₛ^{P} (2)

Here, subscript s denotes “Solid”.

Similarly, for a liquid, Equation (2) is given:

γ_{L}=γ_{L}^{d}+γ_{L}^{P} (3)

Subscript L denotes “Liquid”.

The surface free energy of a film can be calculated from the contact angles obtained by dripping equal amount of the two liquids, for example, water and CH₂I₂ (diiodomethane) on a solid.

The following computation equation was employed based on the Owens-Wendt-Kaelble method:

$$\frac{1}{2} \times {γ}_{L} \times ( 1 + cos θ ) = {( {γ}_{s}^{d} \times {γ}_{L}^{d} )}^{\frac{1}{2}} + {( {γ}_{s}^{p} \times {γ}_{L}^{p} )}^{\frac{1}{2}} \qquad ( 4 )$$

Employing γ_{L}^{d} and γ_{L}^{P} values from the literature for the two liquids shown in Table 1, the γ_{L} value of each of the two liquids was calculated from Equation (3).

TABLE 1
The energy values of individual liquids (values from the literature)

| | γ_{L}^{d} | γ_{L}^{p} | γ_{L} |
|---|---|---|---|
| Water | 21.8 | 51 | 72.8 |
| Diiodomethane | 50.8 | 0 | 50.8 |

For example, a water contact angle of 104.9° and a diiodomethane contact angle of 72.0° were substituted for θ of Equation (4) and the energy values of Table 1 were employed for the other values. This gave Equations (5) and (6):

$$\begin{matrix}\frac{1}{2} \times 72.8 \times ( 1 + cos 104.9 ) = {( {γ}_{s}^{d} \times 21.8 )}^{\frac{1}{2}} + {( {γ}_{s}^{p} \times 51.0 )}^{\frac{1}{2}} & ( 5 ) \\ 27.04 = 4.67 \times {( {γ}_{s}^{d} )}^{\frac{1}{2}} + 7.14 \times {( {γ}_{s}^{p} )}^{\frac{1}{2}} & \\ \frac{1}{2} \times 50.8 \times ( 1 + cos 72.0 ) = {( {γ}_{s}^{d} \times 50.8 )}^{\frac{1}{2}} + {( {γ}_{s}^{p} \times 0 )}^{\frac{1}{2}} & ( 6 ) \\ 33.25 = 7.13 \times {( {γ}_{s}^{d} )}^{\frac{1}{2}} + 0 & \\ ∴ {γ}_{s}^{d} = 21.76 & \end{matrix}$$

Substituting γs^{d} obtained from Equation (6) into Equation (5) gave:

$$27.04 = 4.67 \times {( 21.76 )}^{\frac{1}{2}} + 7.14 \times {( {γ}_{s}^{p} )}^{\frac{1}{2}} \\ ∴ {γ}_{s}^{p} = 0.59 \qquad ( 7 )$$

Substituting the values of Equations (6) and (7) into Equation (2) gave:

γₛ=21.76+0.59=22.30

Thus, a solid surface free energy γs of 22.30 mJ/m² was obtained.

When the surface energy of the glass molding material is low, there are large amounts of alkali metal-based grime or organic grime. Table 2 gives the results of an examination of the relation (transition) between surface free energy and defect rates in the antireflective film in which press-molded optical elements of borosilicate optical glass (nd 1.80610, νd40.70, Tg 560° C., and Ts 600° C.) were subjected to wet cleaning, left for 3 days in air indoors, and subjected to plasma cleaning, with subsequent variation in the time. The results in Table 2 reveal that cleaning increased the level of surface free energy, and that as the level of surface free energy of the optical element increased, the rate of film adhesion defects in the antireflective film decreased. In particular, film adhesion defects disappeared when the surface free energy was greater than or equal to 60 mJ/m².

TABLE 2

| | | | Film | |
|---|---|---|---|---|
| Surface free | Film | | unevenness, | |
| energy | weakness*1 | Film separation | film scorching | Total |
| <50 mJ/m² | 2 lots | 5% | 5% | 17% |
| 50-59 mJ/m² | 2 lots | 3% | 2% | 9% |
| 60-64 mJ/m² | 0 lots | 0% | 0% | 0% |
| ≧65 mJ/m² | 0 lots | 0% | 0% | 0% |

*1Film weakening is the result of an examination of a tape peeling test and a scratch test conducted on 10 samples from each of 10 lots on which films were formed.

The presence of film separation was evaluated by visual and microscopic observation. The presence of film unevenness and film scorching was evaluated visually and by measurement of reflectance.

The results of Table 2 also clearly indicate that when an antireflective film was formed on an optical element having a surface energy of greater than or equal to 60 mJ/m², defects such as film weakness, film separation, film unevenness, and film scorching in the antireflective film due to grime on the surface of the optical element disappeared.

The present invention, devised on the basis of these results, resides in the discovery that by keeping the surface free energy of an optical glass element greater than or equal to 60 mJ/m², it is possible to sharply reduce defects in the antireflective film. It is preferable for the surface energy of the optical element to be greater than or equal to 65 mJ/m².

The contact angle is desirably less than or equal to 55 degrees when employing pure water and more than or equal to 70 degrees when employing diiodomethane.

During press molding, annealing, and core removal, inorganic and organic grime adheres to and adsorbs to the surface of the optical element. Accordingly, it is first important to conduct precision cleaning of the optical element to keep the surface free energy of the press-molded optical element greater than or equal to 60 mJ/m². Further, organic grime increases over time during storage of the optical element. As a result, the surface free energy decreases over time after cleaning. Thus, storing the optical element in a clean environment is also important. In particular, it is important to store optical elements that have been cleaned in a clean environment.

Optical elements having good antireflective film adhesion, for example, optical elements having a surface free energy of greater than or equal to 60 mJ/m², can be obtained by subjecting press-molded optical elements to wet cleaning, UV ozone cleaning, or plasma cleaning. More specifically, the optical element can be precision cleaned by suitably employing wet methods based on the principles of physically peeling off grime, dissolving grime, and lifting off grime accompanying substrate surface etching; and dry methods of decomposing grime by oxidation, represented by UV ozone and plasma processing.

Wet methods can be conducted in the order of “physical peeling”→“lifting off grime accompanying substrate surface etching”→“dissolution of grime”. In “physical peeling”, ultrasound and brushing are employed. Cleaning agents (acidic, neutral, alkaline) and other chemicals are added to enhance the cleaning effect and grime is removed with good efficiency through physical, chemical and synergistic effects. Pure water can be employed in rinsing. In “lifting off grime accompanying substrate surface etching”, the glass molding material is immersed in a solution to which has been added an acid or alkaline chemical suited to etching the surface of the glass molding material. To enhance the effect, means such as ultrasound and heating may be employed. Pure water can be employed in rinsing. Further, in “dissolution of grim”, particularly for organic grime, the glass molding material is immersed in an organic solvent of ethyl ether, acetone, isopropyl alcohol, or the like. To enhance the effect, means such as ultrasound and heating can be employed. Isopropyl alcohol is generally employed in rinsing, with the use of vapor drying being desirable following rinsing.

When employing an acid or alkali in wet cleaning resulting in white or blue scorching, the optical element loses its properties. Thus, for example, an acid or alkali of pH 3-9, preferably pH 5-8, is desirably employed.

The surface of an optical element can be cleaned by UV ozone treatment as follows.

In a UV ozone treatment, the oxidizing power of oxygen radicals and ozone (O₃) excited by UV (ultraviolet) radiation and the breaking down of the bonds of contaminants by UV (ultraviolet) radiation are used to clean. The irradiation of an optical element for a period of from several tens of seconds to several tens of minutes with a UV radiation source such as an excimer lamp in air, for example, using a known UV ozone treatment device can clean the surface of the optical element.

Optical element cleaning by plasma treatment can be conducted as follows.

Plasma treatment is a method of cleaning by exploiting the breaking down of bonds in contaminants through attack by the electrons, ions, and radicals present in plasma. Oxygen, hydrogen, fluorine, chlorine, argon, or nitrogen can be employed as the source of the plasma. The surface of an optical element can be cleaned by a known plasma treatment; for example, generating a vacuum of about 10⁻⁴ Torr, backfilling with oxygen gas, exciting an oxygen plasma with 500 W of RF oscillation power, and keeping the optical element in the oxygen plasma for from several minutes to several tens of minutes. The optical element is desirably heated to a temperature of from about 100 to 200° C.

In the manufacturing method of the present invention, the press-molded optical element is desirably stored in a clean atmosphere with a cleanliness class of less than or equal to 1,000 until formation of the antireflective film. The phrase “clean atmosphere with a cleanliness class of less than or equal to 1,000” means an atmosphere containing at a maximum 1,000 particles of dust 0.5 micrometer in size per cubic foot based on U.S. Federal Standard 209. It is preferred that the atmosphere satisfies the cleanliness Class 6 according to ISO 14644-1 Standard.

The optical element having surface free energy of greater than or equal to 60 mJ/m² is desirably stored in a clean environment from which sources of organic contamination have been eliminated, such as a clean room or clean booth with a cleanliness of class of less than or equal to 1,000 according to Fed-Std-209 or cleanliness class 6 according to ISO 14644-1 Standard. Even an optical element that has been precleaned and stored in a clean room or clean booth is desirably recleaned immediately prior to formation of the antireflective film, with a dry cleaning method such as UV ozone or plasma being preferred.

The antireflective film is desirably formed with the optical element in a state with a surface free energy of greater than or equal to 60 mJ/m². One method of accomplishing this is to conduct a sampling inspection of the surface free energy of each lot of optical elements prior to formation of the antireflective film, sending on only those lots of optical elements having a minimum surface free energy of greater than or equal to 60 mJ/m² to the film formation step, and sending those lots of optical elements having a minimum surface free energy of less than 60 mJ/m² back to the recleaning step. That is, at least some of the molded optical elements are measured for surface cleanliness. Those with a surface free energy corresponding to greater than or equal to 60 mJ/m² are desirably selected and sent on to the step of forming the antireflective film, and those with a surface free energy corresponding to less than 60 mJ/m² are desirably sent back to a step of increasing the surface free energy. It is effective to determine in advance the correlation between cleaning methods and storage methods so that the variation in the surface free energy within a given lot is less than or equal to ±2 mJ/m².

In addition to being effectively applied to the manufacturing of optical glass elements such as lenses, prisms, mirrors, gratings, microlenses, and stacked diffraction gratings, the manufacturing method of the present invention may also be applied to glasses other than optical glass elements. The manufacturing method of the present invention is suited to optical lenses having at least one aspherical surface. The lens of the optical element manufactured by the manufacturing method of the present invention may be biconvex, convex meniscus, biconcave, or concave meniscus in shape; there are no limits. The application of the optical lens is not specifically limited; it can be suitably employed as an image pickup lens in a camera (including video cameras, digital cameras, and cameras with built-in mobile terminals), optical pickup lens, or the like.

Generally, antireflective film adhesion tends to deteriorate to a high degree in small-diameter lenses and lenses with small radii of curvature. However, lenses having high-quality antireflective films can be obtained by the manufacturing method of the present invention. For example, the manufacturing method of the present invention is suited to the manufacturing of objective lenses for optical pickup having lens diameters of less than or equal to 2 mm and radii of curvature of less than or equal to 3 mm.

### EMBODIMENTS

The present invention is described in detail below through embodiments.

### Embodiment 1

A concave meniscus lens 11 mm in diameter with a center thickness of 1.0 mm was formed from a preshaped glass preform of a glass molding material comprised of borosilicate optical glass (refractive index nd of 1.7433, Abbé number νd of 49.3, Tg of 555° C., and Ts of 595° C.). Prior to press molding, a carbon film was coated on the surface of the glass material by CVD (acetylene thermal decomposition method).

Next, the preform was heated to 650° C. in nitrogen gas at a pressure of 150 kg/cm² and pressed for 2 minutes. The pressure was removed, after which cooling was conducted at a rate of 50° C./min. to 530° C., followed by a rate of greater than or equal to 200° C./min. Once the temperature of the molded article had dropped below 200° C., it was removed and annealed at 525° C., yielding a lens.

A commercial optical precision cleaning device was employed to clean the molded lens with high precision by a wet cleaning method. The cleaning device had eight ultrasound vats in the configuration: water→cleaning agent→water→pure water→pure water→IPA→IPA→IPA. Drying was then conducted in an IPA vapor drying vat. The clean optical element was stored in an environment of high cleanliness in the form of a clean case with a cleanliness of class 100.

Prior to formation of an antireflective film, a sampling inspection of the optical elements in each lot that had been cleaned and stored was conducted. A commercial contact angle measuring device was used to measure the contact angles of pure water and CH₂I₂, and the Owens-Wendt-Kaelble method was used to evaluate the free surface energy from the measurements. The lowest level of surface free energy of any of the lots was 63 mJ/m².

Next, an antireflective film was formed with a commercial optical vapor deposition device. The antireflective film had a seven-layer structure: substrate/ Al₂O₃ film (84 nm in thickness)/90 percent ZrO₂-10 percent TiO₂ film (9 nm in thickness)/Al₂O₃ film (55 nm in thickness)/90 percent ZrO₂-10 percent TiO₂ film (70 nm in thickness)/Al₂O₃ film (15 nm in thickness)/90 percent ZrO₂-10 percent TiO₂ film (45 nm in thickness)/MgF₂ film (106 nm in thickness). The substrate temperature was 300° C. and the vacuum was 8×10⁻⁴ Pa in film formation. FIG. 2 shows an example of the reflectance spectrum.

An examination of the antireflective films on 15,600 lenses in 20 lots with films (780 lenses/lot with film) revealed no defects such as film separation, film unevenness, or film scorching. An examination of film peeling and film weakness by a tape peeling test and scratching test revealed no defects in any of the 20 lots with films.

### Comparative Example 1

With the exception that the lenses were placed for 4 days in indoor air after cleaning, antireflective lenses were formed on optical lenses prepared in the same manner as in Embodiment 1. A sampling inspection of each cleaned and stored lot was conducted and the Owens-Wendt-Kaelble method was employed on measurements of the contact angles of pure water and CH₂I₂ to evaluate the surface free energy. The minimum level of surface free energy was 51 mJ/m², with 31 percent of the lots having a minimum level of surface free energy of less than 60 mJ/m². These optical elements were separated out for formation of antireflective films. An examination of the antireflective films of these 7,800 lenses in 10 lots with films revealed 303 lenses with film separation (3.9 percent), 289 lenses with film unevenness or scorching (3.7 percent); the defect rate exceeded 7 percent. A film weakness and film peeling examination conducted by tape test and scratch test revealed defects in two of 10 lots with films.

### Embodiments 2-7

With the exception that the glass materials, cleaning methods, and storage methods indicated in Tables 3 and 4 were employed, antireflective films were formed in the same manner as in Embodiment 1. An examination of the antireflective films on 15,600 lenses in 20 lots with films revealed, as indicated in Tables 3 and 4, no film weakness or film peeling, and only an extremely small amount of defects such as film separation, film unevenness, and film scorching.

TABLE 3

| Factor | Embodiment 1 | Comp. Ex. 1 | Embodiment 2 | Embodiment 3 |
|---|---|---|---|---|
| Glass material (nd) | Borosilicate | Borosilicate | Borate optical | Borate optical |
| | optical glass | optical glass | glass | glass (1.69350) |
| | (1.80610) | (1.80610) | (1.69350) | |
| Cleaning method/ | Wet method | Wet method | Wet method → | Wet method → |
| | | | oxygen | oxygen plasma |
| | | | plasma | treatment |
| | | | treatment | |
| Storage method | Stored in | Stored in | Stored in | Stored in |
| | nitrogen gas*2 | indoor air | vacuum | vacuum |
| Contact angle of H₂O | 31 degrees | 56 degrees | 23 degrees | 21 degrees |
| Contact angle of CH₂I₂ | 72 degrees | 51 degrees | 75 degrees | 75 degrees |
| Surface free energy*3 | 63 mJ/m² | 51 mJ/m² | 67 mJ/m² | 68 mJ/m² |
| Ratio of lots having a | 0/20 lots | 6/10 lots | 0/20 lots | 0/20 lots |
| minimum surface free | | | | |
| energy of less than 60 mJ/m² | | | | |
| Film weakness | 0/20 lots | 2/10 lots | 0/20 lots | 0/20 lots |
| Film separation | 0% | 3.9% | 0% | 0% |
| Film | 0% | 3.7% | 0.01% | 0% |
| unevenness/scorching | | | | |
| Overall evaluation | Excellent | Defect | Good | Excellent |

*2Placed in vacuum desiccator; cycle of evacuation to vacuum of less than or equal to 10⁻² Torr and backfilling with nitrogen gas until nitrogen reached air pressure repeated three times; and then stored in nitrogen atmosphere.
*3Indicates lowest level of surface free energy of any lot.

TABLE 4

| Factor | Embodiment 4 | Embodiment 5 | Embodiment 6 | Embodiment 7 |
|---|---|---|---|---|
| Glass material (nd) | Phosphate | Phosphate | Phosphate | Fluorophosphate |
| | optical glass | optical glass | optical glass | optical glass |
| | (1.82184) | (1.82184) | (1.68893) | (1.49700) |
| Cleaning method/ | Wet method → | Wet method | Wet method → | Wet method |
| | UV ozone | | oxygen | |
| | cleaning | | plasma | |
| | | | treatment | |
| Storage method | Stored in | Stored in clean | Stored in clean | Stored in clean |
| | nitrogen gas*2 | room | room | room |
| Contact angle of H₂O | 23 degrees | 31 degrees | 19 degrees | 32 degrees |
| Contact angle of CH₂I₂ | 78 degrees | 87 degrees | 79 degrees | 89 degrees |
| Surface free energy*3 | 67 mJ/m² | 63 mJ/m² | 69 mJ/m² | 63 mJ/m² |
| Ratio of lots having a | 0/20 lots | 0/20 lots | 0/20 lots | 0/20 lots |
| minimum surface free | | | | |
| energy of less than 60 mJ/m² | | | | |
| Film weakness | 0/20 lots | 0/20 lots | 0/20 lots | 0/20 lots |
| Film separation | 0% | 0.02% | 0% | 0.04% |
| Film | 0% | 0% | 0% | 0.02% |
| unevenness/scorching | | | | |
| Overall evaluation | Excellent | Good | Excellent | Good |

The present disclosure relates to the subject matter contained in Japanese Patent Application No. 2003-89529 filed on Mar. 28, 2003, which is expressly incorporated herein by reference in its entirety.

What is claimed is:

1 A method of manufacturing an optical element, comprising:
press molding a heat-softened molding material in a pressing mold to form an optical element of desired shape, and
forming an antireflective film on the surface of the optical element obtained,
wherein the antireflective film is formed on the optical element having a surface free energy of greater than or equal to 60 mJ/m².

2 The method of manufacturing according to claim 1, wherein the method further comprises, prior to the forming of the antireflective film, a step in which the surface free energy of the optical element obtained by press molding is increased to greater than or equal to 60 mJ/m².

3 The method of manufacturing according to claim 1 or 2, wherein the optical element having surface free energy of greater than or equal to 60 mJ/m² is obtained by subjecting the optical element obtained by press molding to wet cleaning, UV ozone cleaning, or plasma cleaning.

4 A method of manufacturing an optical element, comprising:
press molding a heat-softened molding material in a pressing mold to form an optical element of desired shape, and
forming an antireflective film on the surface of the optical element obtained,
wherein the optical element is subjected to UV ozone cleaning, or plasma cleaning prior to forming the antireflective film.

5 The method of manufacturing according to claim 1, wherein the optical element obtained by press molding is stored in a clean atmosphere with a cleanliness class of less than or equal to 1,000 until formation of the antireflective film.

6 The method of manufacturing according to claim 4, wherein the optical element obtained by press molding is stored in a clean atmosphere with a cleanliness class of less than or equal to 1,000 until formation of the antireflective film.

7 The method of manufacturing according to claim 1, wherein the molding material has a carbon-containing film on an outer surface thereof.

8 The method of manufacturing according to claim 4, wherein the molding material has a carbon-containing film on an outer surface thereof.
